(19) United States
(12) Patent Application Publication
(10) Pub. No.: US 2009/0045005 A1
(43) Pub. Date: Feb. 19, 2009

(54) Acoustic Diaphragm and Speakers Having the Same

(75) Inventors: Gi-Man Byon, Seoul (KR); Young-Nam Kim, Seoul (KR)

Correspondence Address: MCDERMOTT WILL & EMERY LLP, 18191 VON KARMAN AVE., SUITE 500, IRVINE, CA, 92612-7108, US

(73) Assignee: KH CHEMICALS CO., LTD, Songpa-gu (KR)

(21) Appl. No.: 12/089,900

(22) PCT Filed: Oct. 13, 2006
(86) PCT No.: PCT/KR2006/004139

§ 371 Date: Apr. 10, 2008

(30) Foreign Application Priority Data
Oct. 14, 2005 (KR) 10-2005-0097140

(51) Int. Cl. H04R 7/00

(52) U.S. Cl. 181/167; 977/902; 977/742; 977/762

(57) ABSTRACT

Disclosed herein is an acoustic diaphragm for converting electrical signals into mechanical signals to produce sounds. The acoustic diaphragm comprises carbon nanotubes or graphite nanofibers as reinforcing agents. Preferably, the carbon nanotubes or graphite nanofibers are included or dispersed in the acoustic diaphragm or coated on the surface of the acoustic diaphragm. Since the acoustic diaphragm has excellent physical properties in terms of elastic modulus, internal loss, strength and density, it can effectively achieve superior sound quality and a high output in a particular frequency band as well as in a broad frequency band.

### TECHNICAL FIELD

The present invention relates to an acoustic diaphragm and speakers having the acoustic diaphragm. More specifically, the present invention relates to an acoustic diaphragm comprising carbon nanotubes (CNTs) or graphite nanofibers (GNFs) as reinforcing agents, and speakers having the acoustic diaphragm.

### BACKGROUND ART

Speakers are electrical components that convert electrical energy into mechanical sound energy and are currently utilized in a wide variety of applications, including telephones, mobile communication terminals, computers, television (TV) sets, cassettes, sound devices and automobiles.

Speaker systems generally consist of a diaphragm, a damper, a permanent magnet, an encloser, and other elements. Of these elements, the diaphragm has the greatest effect on the sound quality of the speaker systems.

A dilatational wave occurs due to the variation in the air pressure between the front and the rear of a diaphragm and is transduced into an audible sound wave. The sound quality of speakers largely depends on the vibrational mode of diaphragms used in the speakers. The performance required for speakers is that electrical input signals to the speakers must be fully reproduced. It is preferable for speakers to reproduce sounds of high and constant pressure over a broad frequency range from low-frequency sounds to high-frequency sounds to hing-frequency sounds.

Frequency characteristic curves of speakers are required to have a broad frequency range from the lowest resonant frequency (Fa: the limit frequency for the reproduction of low-frequency sounds) to a higher resonant frequency (Fb: a substantial limit frequency for the reproduction of high-frequency sounds), a high sound pressure, and flat peaks with few irregularities.

In order to achieve the above requirements of speakers, diaphragms must satisfy the following three characteristics.

Firstly, diaphragms must have a high elastic modulus. High resonant frequency is proportional to the sound speed, which is proportional to the square root of elastic modulus. Based on these relationships, when the lowest resonant frequency is constant, the frequency band for the reproduction of sounds can be broadened depending on the increased elastic modulus of diaphragms.

Secondly, diaphragms must have a high internal loss. Irregular peaks found in frequency characteristic curves are due to the occurrence of a number of sharp resonances in vibration systems. Therefore, high internal loss of diaphragms makes resonance peaks regular. That is, in speakers using an acoustic diaphragm with a high internal loss, only a desired sound frequency is vibrated by the acoustic diaphragm and no unwanted vibration occurs. As a result, the occurrence of unnecessary noise or reverberation is reduced and high-frequency peaks can be lowered, so that the original sounds can be effectively produced without being changed.

Thirdly, diaphragms must have a light weight (or a low density). It is desirable that vibration systems including a diaphragm be as light as possible in order to obtain a high sound pressure from an input signal having specific energy. In addition, it is preferable that diaphragms be made of a lightweight material having a high Young's modulus in order to increase the longitudinal wave propagating velocity or sound wave propagating velocity.

It is ideal to use lightweight materials having a high elastic modulus and a high internal loss to produce diaphragms, but these requirements are incompatible with each other. Therefore, to find a material for diaphragms whose requirements are in harmony with each other is a prerequisite for the manufacture of speakers with superior sound quality.

To satisfy the aforementioned requirements associated with the physical properties of diaphragms, many materials for diaphragms have been developed. Examples of such materials for diaphragms include carbon fibers and aramid fibers, which have a high elastic modulus, and polypropylene resins, which have a high internal loss.

As the elastic modulus of a diaphragm increases, the internal loss of the diaphragm decreases but the density of the diaphragm increases. In addition, as the internal loss of a diaphragm increases, the elastic modulus of the diaphragm decreases but the density of the diaphragm increases.

The conventional materials that have widely been used to produce acoustic diaphragms satisfy the aforementioned physical properties to some extent. However, increasing demand for speakers capable of producing high-quality sounds has led to a demand for the acoustic diaphragms having a higher elastic modulus and a higher internal loss than conventional diaphragms.

Therefore, an important task for the production of ideal acoustic diaphragms is to keep an optimum balance between the physical properties.

In this regard, various materials, such as pulp, silk, polyamide, polypropylene, polyethylene (PE), polyetherimide (PEI) and ceramic, have been widely used as materials for acoustic diaphragms. Titanium is currently being used as a material for acoustic diaphragms. In particular, titanium coated with diamond-like carbon is used to increase the quality of high-frequency sounds.

The use of titanium diaphragms causes a lowering of the sound pressure in a high-frequency sound band, at which the balance of sounds is kept. In contrast, diaphragms made of diamond-coated titanium markedly raise the sound pressure.

For example, the sound pressure of titanium diaphragms drops rapidly in a high frequency band of 19 kHz or more. In contrast, diamond-coated diaphragms have twice to three times longer life and more exclusive physical properties than those of titanium diaphragms. Due to these advantages, there is an increasing demand for diamond-coated diaphragms in household electrical appliances, including videocassette recorders (VCRs), headphones and stereos.

Although diaphragms made of titanium coated with diamond-like carbon can achieve superior sound quality, they have the problems of complicated procedure of production and relatively high price of the material, which limit the use of diamond as a material for the diaphragms despite the realization of superior sound quality by the diaphragms.

In the meanwhile, a reduction in the thickness of diaphragms in view of improvement in the sound quality of speakers causes the deterioration in the strength of the diaphragms. Accordingly, diaphragms having a thickness not less than 10□ are coated with sapphire- or diamond-like carbon to improve the strength of the diaphragms. However, the coating of diaphragms having a thickness not greater than 10□ with sapphire- or diamond-like carbon causes the hardening of the diaphragms, thus making it impossible to achieve desired sound quality of speakers.

As the output of conventional micro speakers increases, the movement of diaphragms becomes larger, thus causing the problem of serious divisional vibration arising from distortion of the diaphragms. In attempts to solve the problem, many methods have been employed, for example, a method for reinforcing a diaphragm by introducing a corrugated shape to the diaphragm to prevent the diaphragm from being broken and a method for increasing the thickness of a diaphragm to improve the stiffness of the diaphragm.

Although these methods ensure prevention of distortion and breaking of diaphragms, they cause an increase in the amplitude of low-frequency sounds at a high output of 0.5 watts or higher, and as a result, poor touch and unsatisfactory vibration (movement) of the diaphragms are caused, leading to the raise of the lowest resonant frequency of the diaphragms. This raised lowest resonant frequency makes it difficult to reproduce low-frequency sounds.

A reduction in the thickness of diaphragms in view of miniaturization of the diaphragms leads to enhanced elasticity of the diaphragms but causes the problem of low strength of the diaphragms. The problem is solved by coating diaphragms with sapphire or diamond. However, coating of diaphragms having a small thickness (e.g., 10□ or less) with sapphire or diamond causes hardening of the diaphragms. There is thus a need for the ultra-small acoustic diaphragm having enhanced elasticity and high strength that can be used in micro speakers. Further, there is a need for the acoustic diaphragm having improved physical properties in terms of elasticity, strength and internal loss that can be used in general small and large speakers and piezoelectric speakers (flat panel speakers) as well as micro speakers.

### DISCLOSURE OF INVENTION

### Technical Problem

The present invention has been made in view of the problems, and it is one object of the present invention to provide an acoustic diaphragm comprising highly dispersible carbon nanotubes (CNTs) or graphite nanofibers (GNFs) that has excellent physical properties in terms of elasticity, internal loss, strength and weight, can achieve superior sound quality, and can be widely used in not only general speakers, including micro, small and large speakers, but also in piezoelectric speakers.

It is another object of the present invention to provide speakers having the acoustic diaphragm.

### Technical Solution

In accordance with one aspect of the present invention for achieving the above objects, there is provided an acoustic diaphragm for converting electrical signals into mechanical signals to produce sounds wherein the acoustic diaphragm comprises carbon nanotubes or graphite nanofibers as reinforcing agents.

In a preferred embodiment of the present invention, the carbon nanotubes or graphite nanofibers may be included or dispersed in the acoustic diaphragm to function as reinforcing agents.

In a further preferred embodiment of the present invention, the carbon nanotubes or graphite nanofibers may be coated on the surface of the acoustic diaphragm to function as reinforcing agents. In this preferred embodiment, the carbon nanotubes or graphite nanofibers may be coated on the central portion of the acoustic diaphragm.

In another preferred embodiment of the present invention, the acoustic diaphragm may comprise a polymeric material as a major material. In this preferred embodiment, the polymeric material may be polyethylene (PE), polypropylene (PP), polyetherimide (PEI), polyethylene terephthalate (PET), or a mixture thereof.

In another preferred embodiment of the present invention, the acoustic diaphragm may comprise a pulp or a mixture thereof with a fiber as a major material.

In another preferred embodiment of the present invention, the acoustic diaphragm may comprise a metal selected from aluminum, titanium and beryllium as a major material.

In another preferred embodiment of the present invention, the acoustic diaphragm may comprise a ceramic as a major material.

In another preferred embodiment of the present invention, the carbon nanotubes or graphite nanofibers may be single-walled carbon nanotubes, multi-walled carbon nanotubes, graphite nanofibers, or a mixture thereof.

In another preferred embodiment of the present invention, the carbon nanotubes or graphite nanofibers may have a shape selected from straight, helical, branched shapes and mixed shapes thereof, or may be a mixture of carbon nanotubes or graphite nanofibers having different shapes.

In another preferred embodiment of the present invention, the carbon nanotubes or graphite nanofibers may include at least one material selected from the group consisting of H, B, N, O, F, Si, P, S, Cl, transition metals, transition metal compounds, and alkali metals.

In another preferred embodiment of the present invention, the acoustic diaphragm may comprise a surfactant, stearic acid or a fatty acid to disperse the carbon nanotubes or graphite nanofibers.

In another preferred embodiment of the present invention, the acoustic diaphragm may comprise 0.1 to 50% by weight of the carbon nanotubes or graphite nanofibers, based on the weight of the major material for the acoustic diaphragm.

In another preferred embodiment of the present invention, the acoustic diaphragm may comprise 0.1 to 30% by weight of the carbon nanotubes or graphite nanofibers, based on the weight of the major material for the acoustic diaphragm.

In yet another preferred embodiment of the present invention, the acoustic diaphragm may comprise 0.1 to 20% by weight of the carbon nanotubes or graphite nanofibers, based on the weight of the major material for the acoustic diaphragm.

In accordance with another aspect of the present invention, there are provided speakers comprising the acoustic diaphragm.

In a preferred embodiment of the present invention, the speakers may be micro speakers or piezoelectric speakers.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view of a micro speaker having an acoustic diaphragm of the present invention; and

FIG. 2 is a cross-sectional view of a piezoelectric speaker having an acoustic diaphragm of the present invention.

### BEST MODE FOR CARRYING OUT THE INVENTION

The present invention will now be described in greater detail.

Carbon nanotubes (CNTs) have a structure in which each carbon atom is bonded to adjacent three carbon atoms to form hexagonal rings and sheets of the hexagonal rings arranged in a honeycomb configuration are rolled to form cylindrical tubes.

Carbon nanotubes have a diameter of several tens of angstroms (Å) to several tens of nanometers (nm) and a length of several tens to several thousands of times more than the diameter. Carbon nanotubes exhibit superior thermal, mechanical and electrical properties due to their inherent shape and chemical bonding. For these advantages, a number of researches have been conducted on the synthesis of carbon nanotubes. The utilization of the advantageous properties of carbon nanotubes is expected to overcome technical limitations which have remained unsolved in the art, leading to the development of many novel products, and to provide existing products with new characteristics which have been not observed in the products.

In particular, composites of carbon nanotubes and polymeric materials can achieve desired physical properties, such as tensile strength, electrical properties and chemical properties. The carbon nanotube composites are expected to greatly contribute to improve disadvantages of the polymeric materials in terms of tensile strength, elasticity, electrical properties and durability (Erik T. Thostenson, Zhifeng Ren, Tsu-Wei Chou, Composites Science and Technology 61 (2001) 1899-1912).

A number of conventional studies associated with the use of conventional carbon nanotubes have been done to reinforce polymers. For example, it was reported that the addition of 1% by weight of carbon nanotubes to polystyrene results in 25% and 36-42% increases in tensile stress and elastic modulus, respectively (Qian D, Dickey E C, Andrews R, Rantell T. Applied Physics Letters 2000; 76 (20): 2868-2870).

R. Andrews, Y. Chen et al. reported that single-walled nanotubes can be used as reinforcing agents of petroleum pitch fibers. Specifically, they demonstrated that the tensile strength, elastic modulus and electrical conductivity of petroleum pitch fibers are greatly enhanced by the use of 1% by weight of single-walled nanotubes as reinforcing agents in the petroleum pitch fibers. They also reported that the tensile strength, elastic modulus and electrical conductivity of petroleum pitch fibers with 5% loading of single-walled nanotubes as reinforcing agents are enhanced by 90%, 150% and 340% respectively. Particularly, they anticipated that the binding force between petroleum pitch fibers and carbon nanotubes will be enhanced due to the same aromaticity of the petroleum pitch fibers and the carbon nanotubes (R. Andrews, et al., Applied Physics Letters 75 (1999) 1329-1331).

From the results of these studies, including those of studies that have previously been conducted, it is obvious that the use of carbon nanotubes as reinforcing agents of polymeric materials results in a further improvement in the physical properties of the polymeric materials. Therefore, the results can be applied to the production of acoustic diaphragms having superior performance to that of conventional acoustic diaphragms using polymeric materials alone.

The carbon nanotubes (CNTs) used in the present invention have a structure in which graphite sheets are rolled into tubes, exhibit a high mechanical strength due to the strong covalent bonding between carbon atoms, and exhibit superior mechanical properties due to their high Young's modulus and high aspect ratio. Further, since the carbon nanotubes (CNTs) are composed of carbon atoms, they are light in weight but exhibit excellent physical properties. Thus, the acoustic diaphragm of the present invention using the carbon nanotubes as reinforcing agents has more advantageous properties than improvements expected in the mechanical properties of acoustic diaphragms using other reinforcing agents.

In other words, carbon nanotubes (or graphite nanofibers) used in the acoustic diaphragm of the present invention can be vibrated at a high frequency due to their light weight and good elasticity. In addition, since the carbon nanotubes (or graphite nanofibers) have high mechanical strength despite their small size or high length-to-radius ratio(aspect ratio), their original shape is maintained so that the carbon nanotubes (or graphite nanofibers) can be vibrated at a desired high frequency.

Particularly, the inclusion (coating) of carbon nanotubes as reinforcing agents in a major material for an acoustic diaphragm enables considerable improvements in physical properties, such as elastic modulus, internal loss and density, required for the acoustic diaphragm.

The major material for the acoustic diaphragm of the present invention is not limited so long as the carbon nanotubes or graphite nanofibers can be included or dispersed in the major material for the acoustic diaphragm or coated on the surface of the acoustic diaphragm.

Examples of suitable major materials for the acoustic diaphragm of the present invention include: pulps and mixtures thereof with fibers; reinforced fibers, such as carbon fibers; resins, such as polyethylene (PE), polypropylene (PP), polyetherimide (PEI), polyethylene terephthalate (PET) and mixtures thereof; metals, such as aluminum, titanium and beryllium; ceramics; and mixtures thereof.

Carbon nanotubes or graphite nanofibers can be used as reinforcing agents to reinforce the major material for the acoustic diaphragm.

Examples of suitable carbon nanotubes (CNTs) or graphite nanofibers (GNFs) that can be used in the present invention include, but are not limited to, single-walled carbon nanotubes (SWNTs), multi-walled carbon nanotubes (MWNTs), graphite nanofibers (GNFs), and mixtures and composites thereof. There is no particular restriction as to the shape of the carbon nanotubes (CNTs) or graphite nanofibers (GNFs) so long as the CNTs or GNFs contribute to improve desired physical properties. The carbon nanotubes or graphite nanofibers may have various shapes, such as helical, straight and branched shapes.

To achieve desired physical properties or affinity of the acoustic diaphragm according to the present invention, the carbon nanotubes or graphite nanofibers may include at least one material selected from the group consisting of H, B, N, O, F, Si, P, S, Cl, transition metals, transition metal compounds and alkali metals, or may react with these materials.

The carbon nanotubes or graphite nanofibers used in the present invention may be produced by a method known in the art, such as arc discharge, laser vaporization, plasma enhanced chemical vapor deposition (PECVD), thermal chemical vapor deposition or vapor phase growth.

Uniform dispersion of the carbon nanotubes or graphite nanofibers in the acoustic diaphragm of the present invention is effective in exhibiting inherent physical properties of the carbon nanotubes or graphite nanofibers.

For example, a surfactant may be used to homogeneously disperse the carbon nanotubes (CNTs) or graphite nanofibers (GNFs) in the acoustic diaphragm. Any surfactant that serves to homogeneously distribute the carbon nanotubes or graphite nanofibers and enhance the binding force to improve the physical properties of the acoustic diaphragm may be used, and examples thereof include, but are not particularly limited to, cationic, anionoic and nonionic surfactants. A stearic acid or a fatty acid may also be used.

The carbon nanotubes or graphite nanofibers may be coated on the surface of the acoustic diaphragm to function as reinforcing agents. At this time, the carbon nanotubes or graphite nanofibers may be coated on the central portion of the acoustic diaphragm to enhance the strength of the central portion.

The acoustic diaphragm of the present invention may comprise 0.1 to 50% by weight, preferably 0.1 to 30% by weight and more preferably 0.1 to 20% by weight of the carbon nanotubes or graphite nanofibers, based on the weight of the polymeric material.

### MODE FOR THE INVENTION

The production of an acoustic diaphragm using carbon nanotubes is generally achieved by dispersing carbon nanotubes as reinforcing agents to a polymeric material, thus avoiding the need for special processing or treatment. The present invention will be better understood from the following examples. However, these examples are not to be construed as limiting the scope of the invention.

The physical properties of an acoustic diaphragm produced using a polymeric material and carbon nanotubes as reinforcing agents and those of an acoustic diaphragm produced using the polymeric material alone were measured and compared to evaluate changes in the physical properties of the polymeric material due to the use of the carbon nanotubes as reinforcing agents.

In the following examples, carbon nanotubes were dispersed in a polymeric material for an acoustic diaphragm by the following procedure. First, carbon nanotubes were dispersed in a solvent. Then, a polymeric material was dissolved in the carbon nanotube solution. Thereafter, the solvent was evaporated or removed to obtain a state in which the carbon nanotubes as reinforcing agents were dispersed in the polymeric material.

### EXAMPLES

### Example 1

An acoustic diaphragm was produced using polypropylene and carbon nanotubes as reinforcing agents dispersed in the polypropylene. The carbon nanotubes were used in an amount of 1% by weight, based on the weight of the polypropylene. The carbon nanotubes were single-walled carbon nanotubes (SWNTs) having an average diameter of 1 nm and a length of 1 μm.

First, 10 ml of acetone as a solvent was put in an Erlenmeyer flask and 50 mg of the carbon nanotubes was added thereto. After the mixture was homogeneously mixed using an ultrasonicator, 5 g of polypropylene was slowly added dropwise thereto with violent stirring. For homogeneous mixing, the resulting mixture was stirred for about 30 minutes. After the stirring, the homogeneous mixture was poured into a mold having a diameter of 20 mm and a thickness of 1 mm. The mold was placed in an oven at the temperature of 80° C. and allowed to stand for about one day to evaporate the solvent and stabilize the carbon nanotubes within the polymeric material. The polymeric material was detached from the mold to produce a polypropylene acoustic diaphragm using the carbon nanotubes as reinforcing agents.

### Example 2

The procedure of Example 1 was repeated, except that a surfactant was further used to enhance the degree of dispersion of the carbon nanotubes without changing the conditions employed and the contents of the materials used in Example 1. As the surfactant, polyoxyethylene-8-lauryl ether, CH₃—(CH₂)₁₁(OCH₂CH₂)₇OCH₂CH₃ (hereinafter, referred to simply as “C12EO8”) was used.

First, 10□ of acetone as a solvent was put in an Erlenmeyer flask and 35□ of C12EO8 was homogeneously dissolved in the solvent. 50□ of the carbon nanotubes was added to the C12EO8 solution. After the mixture was homogeneously mixed using an ultrasonicator, 5 g of polypropylene was slowly added dropwise thereto with violent stirring. For homogeneous mixing, the resulting mixture was stirred for about 30 minutes. After the stirring, the homogeneous mixture was poured into a mold having a diameter of 20 mm and a thickness of 1 mm. The mold was placed in an oven at the temperature of 80° C. and allowed to stand for about one day to evaporate the solvent and stabilize the carbon nanotubes within the polymeric material. The polymeric material was detached from the mold to produce a polypropylene acoustic diaphragm using the carbon nanotubes as reinforcing agents.

The carbon nanotubes were homogeneously distributed in the acoustic diaphragm (Example 2) produced using the surfactant, when compared to in the acoustic diaphragm (Example 1) produced without using any surfactant, as observed by an electronic microscope.

Hereinafter, samples were produced using the surfactant in the same manner as in Example 2, except that the kind and the amount of carbon nanotubes or graphite nanofibers were varied as indicated in Table 1. The changes in the elasticity of the samples were measured according to the kind of the polymeric materials used. The results are shown in Table 1. The increases in elasticity of the samples were evaluated on the basis of increases in the elasticity of the same polymer samples without using any carbon nanotubes or graphite nanofibers.

The SWNTs (single wall nanotubes) used herein had an average diameter of 1 nm and a length of 1 μm. The graphite nanofibers (GNFs) used herein were herringbone type graphite nanofibers having an average diameter of 10 nm and a length of 1□.

TABLE 1

| | | | Content | |
|---|---|---|---|---|
| | | | of CNTs | Increase in- |
| Sample No. | Polymer | Kind of CNTs | (wt %) | elasticity (%) |
| 1 | PE | SWNTs | 1 | 21.1 |
| 2 | PE | SWNTs | 5 | 46.8 |
| 3 | PE | SWNTs | 10 | 131.3 |
| 4 | PE | GNFs | 1 | 25.0 |
| 5 | PP | SWNTs | 1 | 23.7 |
| 6 | PP | GNFs | 1 | 31.0 |
| 7 | PET | SWNTs | 1.5 | 32.1 |
| 8 | PEI | GNFs | 0.5 | 14.4 |
| 9 | PEI | GNFs | 15 | 184 |

*Note:
PE—polyethylene, PP—polypropylene, PEI—polyetherimide, PET—polyethylene terephthalate

As can be seen from the results of Table 1, the samples produced using GNFs as reinforcing agents showed higher increases in elasticity than the samples produced using SWNTs as reinforcing agents. These results are believed to be due to strong bonding between the polymeric materials and GNFs arising from a high affinity of the polymeric materials for GNFs. The use of carbon nanotubes as reinforcing agents led to a considerable increase in the elasticity of the acoustic diaphragms.

Carbon nanotubes or graphite nanofibers have a high mechanical strength due to the strong covalent bonding between carbon atoms and a high Young's modulus. In addition, carbon nanotubes or graphite nanofibers have a lower specific weight than the polymeric materials. Therefore, the use of carbon nanotubes or graphite nanofibers in acoustic diaphragms leads to considerable improvements in physical properties, such as strength, and a reduction in weight, thus making it possible to achieve superior sound quality. Carbon nanotubes dispersed in a material, particularly a polymeric material, for an acoustic diaphragm can serve to greatly improve the physical properties, such as elastic modulus, internal loss and density, required for the acoustic diaphragm.

By appropriately controlling the kind and amount of the carbon nanotubes as reinforcing agents, methods for dispersing the carbon nanotubes and the kind of the dispersant (e.g., the surfactant), optimum acoustic diaphragm can be produced using the carbon nanotubes.

Speakers to which the acoustic diaphragm of the present invention can be applied will be explained in more detail with reference to the accompanying drawings.

In general, acoustic reproducers (e.g., speakers) are largely divided into horn speakers, system speakers for use in high-fidelity (Hi-Fi) audio systems (e.g., component systems) including a woofer, a midrange and a tweeter for covering a pre-determined frequency band, general speakers for covering the entire frequency band by a single unit, micro speakers that are ultra-light in weight and ultra-slim in thickness designed to be used micro-camcorders, portable audio recorders (walkmans), personal digital assistants (PDAs), notebook computers, mobile communication terminals, headphones, cellular phones, telephones, radiotelegraphs, etc., receivers for use in mobile communication terminals, earphones whose part is inserted into the user's ear, and buzzers for receiving only a specific frequency band.

The acoustic diaphragm of the present invention can be used in the above-mentioned speakers and is produced so as to have optimum physical properties according to the performance required for the speakers.

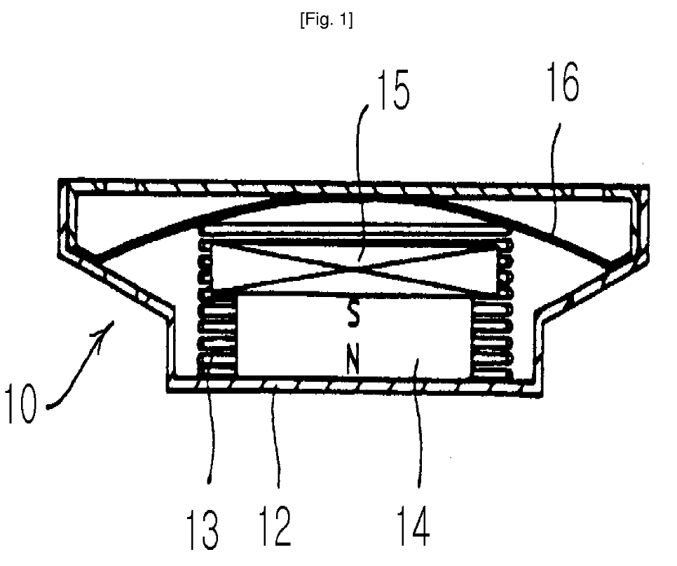

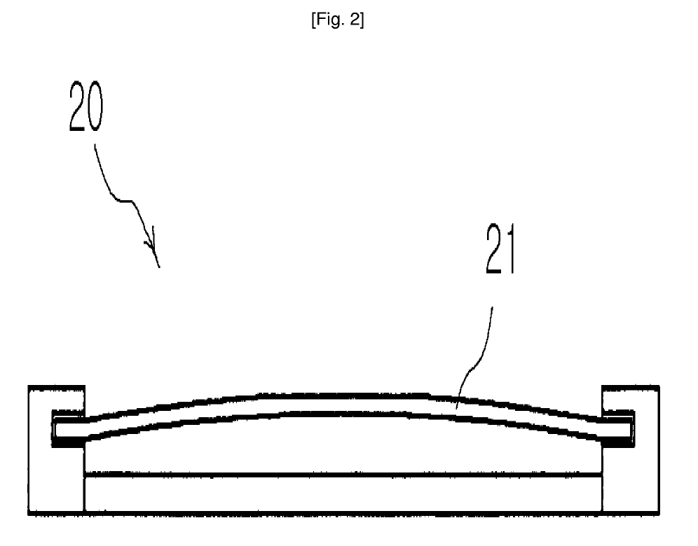

An explanation of a micro speaker and a piezoelectric speaker comprising the acoustic diaphragm of the present invention will be provided below with reference to FIGS. 1 and 2, respectively.

According to the structure of a micro speaker 10 shown in FIG. 1, a magnet 14 and a magnet plate 15 are disposed within a yoke 12, and a voice coil 13 surrounds the periphery of the magnet 14 and magnet plate 15. When a driving signal is generated in a state in which a diaphragm 16 is connected to both ends (i.e. a cathode and an anode) of the voice coil 13, the diaphragm is vibrated to produce a sound.

When a driving signal is applied to the voice coil 13 of the micro speaker 10, a non-alternating (direct current (DC)) magnetic flux is generated in a magnetic circuit passing through the magnet plate 15 via the magnet 14, and an alternating (alternating current (AC)) rotating magnetic flux is generated in the voice coil 13 capable of moving upward and downward. The non-alternating magnetic flux responds to the alternating rotating magnetic flux according to Fleming's left-hand rule to cause attractive and repulsive forces. By the action of the attractive and repulsive forces, the diaphragm 16 and the voice coil 13 are vibrated upward and downward to produce a sound corresponding to the driving signal.

To prevent occurrence of distortion of the diaphragm 16 arising from a high output of the micro speaker 10, many methods have been employed, for example, a method for reinforcing a diaphragm by introducing a corrugated shape to the diaphragm to prevent the diaphragm from being broken and a method for increasing the thickness of a diaphragm. Although these methods ensure prevention of distortion and breaking of diaphragms, they cause an increase in the amplitude of low-frequency sounds at a high output of 0.5 watts or higher and as a result, poor touch and unsatisfactory vibration (movement) of the diaphragms are caused, leading to the raise in the lowest resonant frequency of the diaphragms. This raised lowest resonant frequency makes it difficult to reproduce low-frequency sounds.

On the other hand, a reduction in the thickness of diaphragms leads to enhanced elasticity of the diaphragms but causes the problem of low strength of the diaphragms. The problem is solved by coating diaphragms with sapphire or diamond. However, coating of diaphragms having a small thickness (e.g., 10 μm or less) with sapphire or diamond causes hardening of the diaphragms.

Although the thickness of the diaphragm according the present invention, which comprises carbon nanotubes or graphite nanofibers as reinforcing agents, is reduced, the elasticity of the diaphragm is improved without any deterioration in strength.

FIG. 2 shows the structure of a piezoelectric speaker (a flat panel speaker).

Referring to FIG. 2, a diaphragm 21 used in the piezoelectric speaker 20 is in the form of a thin plate and is required to be highly durable and lightweight.

Due to the physical properties of carbon nanotubes or graphite nanofibers, the diaphragm 21 of the present invention is lightweight, is highly elastic and has a high mechanical strength as compared to conventional diaphragms. Therefore, the piezoelectric speaker 20 having the diaphragm 21 of the present invention can advantageously achieve superior sound quality.

Further, the acoustic diaphragm of the present invention can be widely used in micro speakers, piezoelectric speakers, and small, medium and large speakers, regardless of the shape and structure of the speakers.

### INDUSTRIAL APPLICABILITY

As apparent from the above description, since the acoustic diaphragm of the present invention has excellent physical properties in terms of elastic modulus, internal loss, strength and weight, it can effectively achieve superior sound quality and a high output in a particular frequency band as well as in a broad frequency band.

In addition, since the degree of dispersion of carbon nanotubes in the acoustic diaphragm of the present invention is improved, superior sound quality of speakers can be realized.

Furthermore, the acoustic diaphragm of the present invention can be widely used in not only general speakers, including micro, small, medium and large speakers, but also in piezoelectric speakers (flat panel speakers).

Although the present invention has been described herein with reference to the foregoing specific embodiments, those skilled in the art will appreciate that various modifications and changes are possible, without departing from the scope and spirit of the invention as disclosed in the accompanying claims.

1. An acoustic diaphragm for converting electrical signals into mechanical signals to produce sounds wherein the acoustic diaphragm comprises carbon nanotubes or graphite nanofibers as reinforcing agents.

2. The acoustic diaphragm according to claim 1, wherein the carbon nanotubes or graphite nanofibers are included or dispersed in the acoustic diaphragm to function as reinforcing agents.

3. The acoustic diaphragm according to claim 1, wherein the carbon nanotubes or graphite nanofibers are coated on the surface of the acoustic diaphragm to function as reinforcing agents.

4. The acoustic diaphragm according to claim 3, wherein the carbon nanotubes or graphite nanofibers are coated on the central portion of the acoustic diaphragm to function as reinforcing agents.

5. The acoustic diaphragm according to claim 1, wherein the acoustic diaphragm comprises a polymeric material as a major material.

6. The acoustic diaphragm according to claim 5, wherein the polymeric material is polyethylene (PE), polypropylene (PP), polyetherimide (PEI), polyethylene terephthalate (PET), or a mixture thereof.

7. The acoustic diaphragm according to claim 1, wherein the acoustic diaphragm comprises a pulp or a mixture thereof with a fiber as a major material.

8. The acoustic diaphragm according to claim 1, wherein the acoustic diaphragm comprises a metal selected from aluminum, titanium and beryllium as a major material.

9. The acoustic diaphragm according to claim 1, wherein the acoustic diaphragm comprises a ceramic as a major material.

10. The acoustic diaphragm according to claim 1, wherein the carbon nanotubes or graphite nanofibers are single-walled carbon nanotubes, multi-walled carbon nanotubes, graphite nanofibers, or a mixture thereof.

11. The acoustic diaphragm according to claim 10, wherein the carbon nanotubes or graphite nanofibers have a shape selected from straight, helical, branched shapes and mixed shapes thereof, or are a mixture of carbon nanotubes or graphite nanofibers having different shapes.

12. The acoustic diaphragm according to claim 10, wherein the carbon nanotubes or graphite nanofibers includes at least one material selected from the group consisting of H, B, N, O, F, Si, P, S, CI, transition metals, transition metal compounds, and alkali metals.

13. The acoustic diaphragm according to claim 1, wherein the acoustic diaphragm comprises a surfactant, stearic acid or a fatty acid to disperse the carbon nanotubes or graphite nanofibers.

14. The acoustic diaphragm according to claim 1, wherein the acoustic diaphragm comprises 0.1 to 50% by weight of the carbon nanotubes or graphite nanofibers, based on the weight of a major material for the acoustic diaphragm.

15. The acoustic diaphragm according to claim 1, wherein the acoustic diaphragm comprises 0.1 to 30% by weight of the carbon nanotubes or graphite nanofibers, based on the weight of a major material for the acoustic diaphragm.

16. The acoustic diaphragm according to claim 1, wherein the acoustic diaphragm comprises 0.1 to 20% by weight of the carbon nanotubes or graphite nanofibers, based on the weight of a major material for the acoustic diaphragm.

17. A speaker comprising the acoustic diaphragm according to claim 1.

18. A micro speaker comprising the acoustic diaphragm according to claim 1.

19. A piezoelectric speaker comprising the acoustic diaphragm according to claim 1.

20. The acoustic diaphragm according to claim 11, wherein the carbon nanotubes or graphite nanofibers includes at least one material selected from the group consisting of H, B, N, O, F, Si, P, S, CI, transition metals, transition metal compounds, and alkali metals.
